(19) United States
(12) Patent Application Publication
(10) Pub. No.: US 2024/0259992 A1
(43) Pub. Date: Aug. 1, 2024

(54) APPARATUS AND METHOD FOR UPDATING TRP INFORMATION BY CONSIDERING LOCALIZATION OF TERMINAL IN MOVING CELL IN MOBILE COMMUNICATION SYSTEM

(71) Applicant: Samsung Electronics Co., Ltd., Suwon-si (KR)

(72) Inventors: June HWANG, Suwon-si (KR); Hyunjeong KANG, Suwon-si (KR); Beomsik BAE, Suwon-si (KR); Taeseop LEE, Suwon-si (KR)

(21) Appl. No.: 18/422,637

(22) Filed: Jan. 25, 2024

(30) Foreign Application Priority Data
Jan. 27, 2023 (KR) 10-2023-0011045

(51) Int. Cl. H04W 64/00; H04W 24/10; H04W 88/08

(52) U.S. Cl. CPC H04W 64/006; H04W 24/10; H04W 88/08

(57) ABSTRACT

The disclosure relates to a fifth generation (5G) or sixth generation (6G) communication system for supporting a higher data transmission rate. A method performed by a base station in a wireless communication system is provided. The method includes receiving, from a location management function (LMF) entity, a transmission reception point (TRP) information request message including at least one TRP identification (ID), and transmitting, to the LMF entity, a TRP information response message including first indication information indicating that a TRP corresponding to the TRP ID is a moving cell.

### CROSS-REFERENCE TO RELATED APPLICATION(S)

This application is based on and claims priority under 35 U.S.C. § 119(a) of a Korean patent application number 10-2023-0011045, filed on Jan. 27, 2023, in the Korean Intellectual Property Office, the disclosure of which is incorporated by reference herein in its entirety.

### BACKGROUND

### 1. Field

The disclosure relates to an apparatus and a method for updating transmission reception point (TRP) information by considering localization of a terminal in a moving cell in a mobile communication system.

### 2. Description of Related Art

Fifth generation (5G) mobile communication technologies define broad frequency bands such that high transmission rates and new services are possible, and can be implemented not only in “Sub 6 GHz” bands such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BandWidth Part (BWP), new channel coding methods such as a Low Density Parity Check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, new radio (NR) user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, Integrated Access and Backhaul (IAB) for providing a node for network service area expansion by supporting a wireless backhaul link and an access link in an integrated manner, mobility enhancement including conditional handover and Dual Active Protocol Stack (DAPS) handover, and two-step random access for simplifying random access procedures (2-step Random Access Channel (RACH) for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and Artificial Intelligence (AI) from the design stage and internalizing end-to-end AI support functions, and next-generation distributed computing technology for implementing services at levels of complexity exceeding the limit of UE operation capability by utilizing ultra-high-performance communication and computing resources.

With the advance of mobile communication systems as described above, various services can be provided, and accordingly there is a need for schemes to effectively provide these services.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an apparatus and a method for effectively providing a location service of a terminal in a mobile communication system.

Additional aspects will be set forth in part in the description which follows and, in part, will be apparent from the description, or may be learned by practice of the presented embodiments.

In accordance with an aspect of the disclosure, a method performed by a base station in a wireless communication system is provided. The method includes receiving, from a location management function (LMF) entity, a transmission reception point (TRP) information request message including at least one TRP identification (ID), and transmitting, to the LMF entity, a TRP information response message including first indication information indicating that a TRP corresponding to the TRP ID is a moving cell.

In accordance with another aspect of the disclosure, a method of a LMF entity in a wireless communication system is provided. The method includes transmitting, to a base station, a TRP information request message including TRP ID, and receiving, from the base station, a TRP information response message including indication information indicating that a TRP corresponding to the TRP ID is a moving cell.

In accordance with another aspect of the disclosure, a base station in a wireless communication system is provided. The base station includes a transceiver, and a controller coupled to the transceiver, and configured to receive, from a LMF entity, a TRP information request message including at least one TRP ID, and transmit, to the LMF entity, a TRP information response message including first indication information indicating that a TRP corresponding to the TRP ID is a moving cell.

In accordance with another aspect of the disclosure, a LMF entity in a wireless communication system is provided. The LMF entity includes a transceiver, and a controller coupled to the transceiver, and configured to transmit, to a base station, a TRP information request message including TRP ID, and receive, from the base station, a TRP information response message including indication information indicating that a TRP corresponding to the TRP ID is a moving cell.

According to various embodiments of the disclosure, an apparatus and a method for effectively providing a service in a wireless communication system may be provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a structure of a general long term evolution (LTE) system according to an embodiment of the disclosure;

FIG. 2 is a diagram illustrating a wireless protocol structure of a general LTE system according to an embodiment of the disclosure;

FIG. 3 is a diagram illustrating a structure of a next generation mobile communication system according to an embodiment of the disclosure;

FIG. 4 is a diagram illustrating a wireless protocol structure of a next generation mobile communication system according to an embodiment of the disclosure;

FIG. 5 is a block diagram illustrating an internal structure of a terminal according to an embodiment of the disclosure;

FIG. 6 is a block diagram illustrating a configuration of a new radio (NR) base station according to an embodiment of the disclosure;

FIG. 7 is a diagram illustrating an operation of a transmission reception point (TRP) information request/response message in a process of obtaining location information of a terminal according to an embodiment of the disclosure;

FIG. 8 is a diagram illustrating an operation of periodically transmitting one TRP information response message according to an embodiment of the disclosure; and

FIG. 9 is a diagram illustrating an operation of requesting an event-driven TRP information response/update according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In describing the embodiments, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not completely reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in the embodiments of the disclosure, the “unit” refers to a software element or a hardware element, such as a Field Programmable Gate Array (FPGA) or an Application Specific Integrated Circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” or may be implemented to reproduce one or more central processing units (CPUs) within a device or a security multimedia card. Furthermore, the “unit” in the embodiments may include one or more processors.

In the following description of the disclosure, a detailed description of known functions or configurations incorporated herein will be omitted when it is determined that the description may make the subject matter of the disclosure unnecessarily unclear. Hereinafter, embodiments of the disclosure will be described with reference to the accompanying drawings.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used below, and other terms referring to subjects having equivalent technical meanings may be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. Of course, examples of the base station and the terminal are not limited thereto. In the disclosure, a “downlink (DL)” refers to a radio link via which a base station transmits a signal to a terminal, and an “uplink (UL)” refers to a radio link via which a terminal transmits a signal to a base station.

A wireless communication system is advancing to a broadband wireless communication system for providing high-speed and high-quality packet data services using communication standards, such as high-speed packet access (HSPA) of third generation partnership project (3GPP), long-term evolution (LTE) or evolved universal terrestrial radio access (E-UTRA), LTE-Advanced (LTE-A), LTE-Pro, high-rate packet data (HRPD) of 3GPP2, ultra-mobile broadband (UMB), IEEE 802.16e, and the like, as well as typical voice-based services.

Since a 5^{th} generation (5G) communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

According to some embodiments, eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. In addition, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC, which is a cellular-based mission-critical wireless communication service, may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and also requires a packet error rate of 10-5 or less. Therefore, for the services supporting URLLC, a 5G system must provide a transmit time interval (TTI) shorter than those of other services, and also may require a design for assigning a large number of resources in a frequency band in order to secure reliability of a communication link.

The above-described three services considered in the 5G communication system, that is, eMBB, URLLC, and mMTC, may be multiplexed and transmitted in a single system. In order to satisfy different requirements of the respective services, different transmission/reception techniques and transmission/reception parameters may be used between the services. However, the above mMTC, URLLC, and eMBB are merely examples of different types of services, and service types to which the disclosure is applied are not limited to the above examples.

In the following description of the disclosure, terms and names specified in the 5G system (5GS) and NR standards, which are standards defined by the 3rd generation partnership project (3GPP) among the existing communication standards, will be used for the sake of descriptive convenience. However, the disclosure is not limited by these terms and names, and may be applied in the same way to systems that conform other standards. For example, the disclosure may be applied to 3GPP 5GS/NR (5th generation mobile communication standards).

The disclosure describes a procedure in which a base station having received a request for TRP-related information from a location server responds to a periodic or particular event to report the TRP-related information.

It should be appreciated that the blocks in each flowchart and combinations of the flowcharts may be performed by one or more computer programs which include instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphical processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

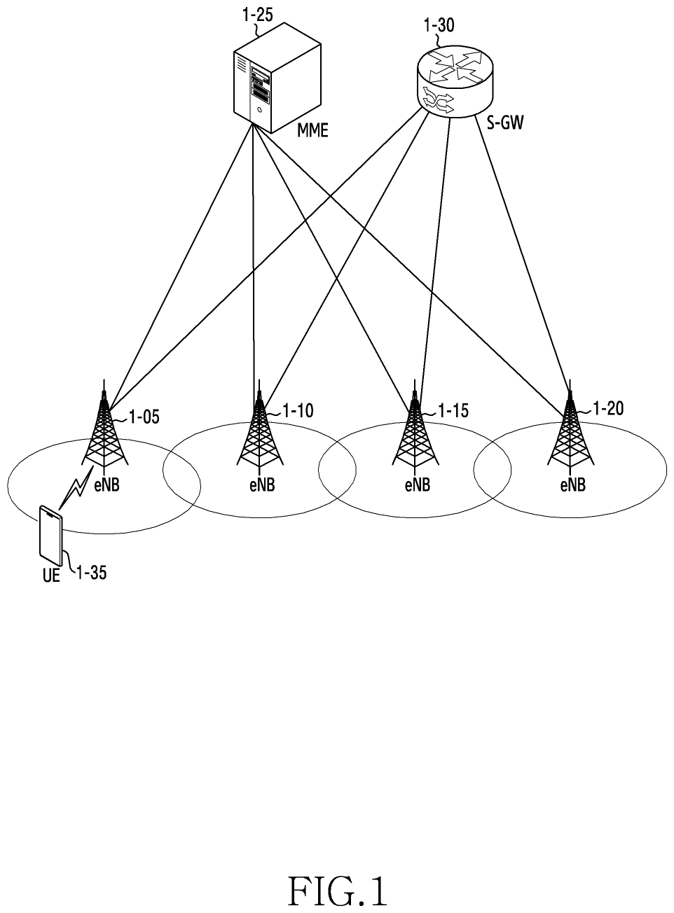

FIG. 1 is a diagram illustrating a structure of a general LTE system according to an embodiment of the disclosure.

Referring to FIG. 1, as illustrated therein, a wireless access network of an LTE system may include next generation base stations (evolved node Bs, hereinafter, ENBs, node Bs, or base stations) 1-05, 1-10, 1-15, and 1-20, a mobility management entity (MME) 1-25, and a serving gateway (S-GW) 1-30. A user equipment (hereinafter, a UE or a terminal) 1-35 may access an external network via the ENBs 1-05 to 1-20 and the S-GW 1-30.

Referring to FIG. 1, the ENBs 1-05 to 1-20 may correspond to a conventional node B of a universal mobile telecommunication system (UMTS). The ENB may be connected to the UE 1-35 through a wireless channel and may perform more complex roles compared to a conventional node B. In the LTE system, all the user traffic including real-time services such as a voice over IP (VoIP), which is performed through the Internet protocol, may be serviced through a shared channel. Therefore, the LTE system may require a device that collects state information, such as a buffer state, an available transmission power state, and a channel state of UEs, and performs scheduling, and the ENBs 1-05 to 1-20 may serve as the device. A single ENB may commonly control multiple cells. For example, the LTE system may use, as a wireless access technology, for example, orthogonal frequency division multiplexing (OFDM) in a bandwidth of 20 MHz in order to implement a transfer rate of 100 Mbps. Furthermore, the LTE system may apply an adaptive modulation & coding (AMC) scheme for determining a modulation scheme and a channel coding rate according to a channel state of a terminal. The S-GW 1-30 is a device that provides a data bearer, and may generate or remove a data bearer according to a control of the MME 1-25. The MME is a device that performs various control functions as well as a mobility management function for a terminal, and may be connected to a plurality of base stations.

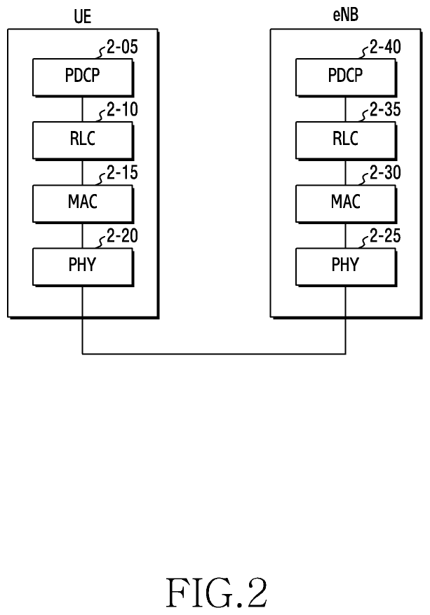

FIG. 2 is a diagram illustrating a wireless protocol structure of a general LTE system according to an embodiment of the disclosure.

Referring to FIG. 2, a wireless protocol of an LTE system may include a packet data convergence protocol (PDCP) 2-05 or 2-40, a radio link control (RLC) 2-10 or 2-35, and a medium access control (MAC) 2-15 or 2-30 in each of a terminal and an ENB. The PDCP may function to perform an operation such as IP header compression/reconstruction. Main functions of the PDCP may be summarized as below. The PDCP may perform various functions without being limited to the following example.
Header compression and decompression (robust header compression (ROHC) only).
Transfer of user data.
In-sequence delivery (In-sequence delivery of upper layer protocol data units (PDUs) at packet data convergence protocol (PDCP) re-establishment procedure for radio link control (RLC) acknowledged mode (AM)).
Reordering (For split bearers in dual connectivity (DC) (only support for RLC AM): PDCP PDU routing for transmission and PDCP PDU reordering for reception).
Duplicate detection (Duplicate detection of lower layer service data units (SDUs) at PDCP re-establishment procedure for RLC AM).
Retransmission (Retransmission of PDCP SDUs at handover and, for split bearers in DC, of PDCP PDUs at PDCP data-recovery procedure, for RLC AM).
Ciphering and deciphering.
Timer-based SDU discard (Timer-based SDU discard in uplink).

The radio link control (RLC) 2-10 or 2-35 may reconfigure a PDCP packet data unit (PDU) to have a proper size, so as to perform an automatic repeat request (ARQ) operation, etc. Main functions of the RLC may be summarized as below. The RLC may perform various functions without being limited to the following example.
Data transfer (Transfer of upper layer PDUs).
ARQ (Error correction through ARQ (only for AM data transfer)).
Concatenation, segmentation and reassembly (Concatenation, segmentation and reassembly of RLC SDUs (only for UM and AM data transfer)).
Re-segmentation (Re-segmentation of RLC data PDUs (only for AM data transfer)).
Reordering (Reordering of RLC data PDUs (only for UM and AM data transfer)).
Duplicate detection (only for UM and AM data transfer).
Error detection (Protocol error detection (only for AM data transfer)).
RLC service data unit (SDU) discard (only for unacknowledged mode (UM) and AM data transfer).
RLC re-establishment.

The MAC 2-15 or 2-30 is connected to several RLC layer devices configured in a single terminal, and may multiplex RLC protocol data units (PDUs) to a MAC PDU and demultiplex a MAC PDU to RLC PDUs. Main functions of the MAC may be summarized as below. The MAC may perform various functions without being limited to the following example.
Mapping (Mapping between logical channels and transport channels).
Multiplexing and demultiplexing (Multiplexing/demultiplexing of MAC SDUs belonging to one or different logical channels into/from transport blocks (TB) delivered to/from the physical layer on transport channels).
Scheduling information reporting.
Hybrid automatic repeat request (HARQ) (Error correction through HARQ).
Priority handling between logical channels (Priority handling between logical channels of one UE).
Priority handling between UEs (Priority handling between UEs by means of dynamic scheduling).
Multimedia broadcast and multicast service (MBMS) identification.
Transport format selection.
Padding.

A physical (PHY) layer 2-20 or 2-25 may perform channel coding and modulation of higher layer data to make the data into OFDM symbols and transmit the OFDM symbols through a wireless channel, or may perform demodulation and channel decoding of OFDM symbols received through a wireless channel, and then transfer the OFDM symbols to a higher layer. The physical layer may perform various functions without being limited to this example.

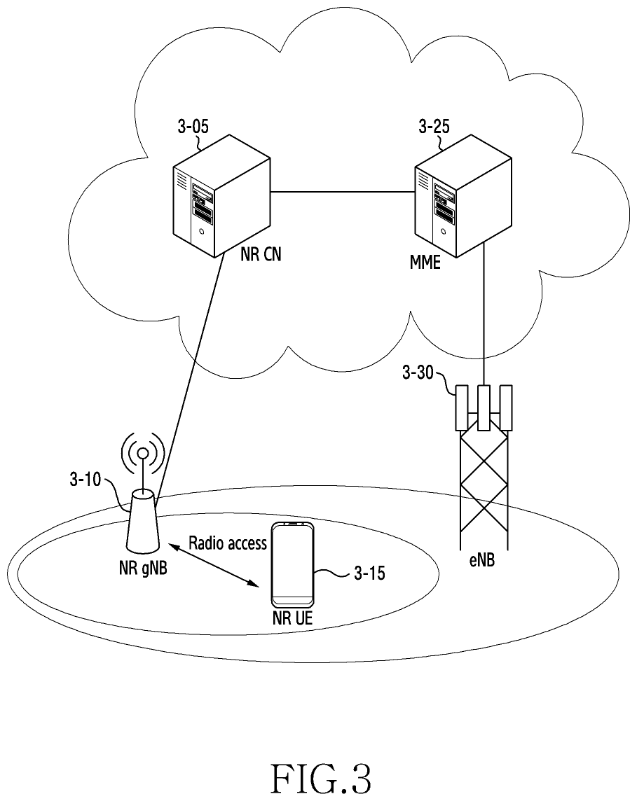

FIG. 3 is a diagram illustrating a structure of a next generation mobile communication system according to an embodiment of the disclosure.

Referring to FIG. 3, a wireless access network of a next generation mobile communication system (hereinafter, NR or 2g) may include a next generation base station (a new radio node B, hereinafter, an NR gNB or an NR base station) 3-10 and a next generation wireless core network (a new radio core network, NR CN) 3-05. A next generation wireless user terminal (new radio user equipment, an NR UE, or a terminal) 3-15 may access an external network via the gNB 3-10 and the NR CN 3-05.

Referring to FIG. 3, the NR gNB 3-10 may correspond to an evolved node B (eNB) of a conventional LTE system. The NR gNB is connected to the NR UE 3-15 through a wireless channel and may provide an outstanding service compared to a conventional node B. In the NR system, all the user traffic may be serviced through a shared channel. Therefore, the NR system may require a device that collects state information, such as a buffer state, an available transmission power state, and a channel state of UEs, and performs scheduling, and the NR NB 3-10 may serve as the device. A single NR gNB may control a plurality of cells. In order to implement ultra-high speed data transfer compared to the current LTE, the NR system may employ a bandwidth larger than or equal to the current maximum bandwidth. In addition, beamforming technology may be additionally integrated with orthogonal frequency division multiplexing (OFDM) as a wireless access technology. Furthermore, an adaptive modulation and coding (hereinafter, referred to as an AMC) scheme for determining a modulation scheme and a channel coding rate according to a channel state of a terminal may be applied. The NR CN 3-05 may perform functions such as mobility support, bearer configuration, and QoS configuration. The NR CN is a device that performs various control functions as well as a mobility management function for a terminal, and may be connected to a plurality of base stations. In addition, the NR system may be linked to a conventional LTE system, and the NR CN may be connected to an MME 3-25 via a network interface. The MME may be connected to an eNB 3-30 that is a conventional base station.

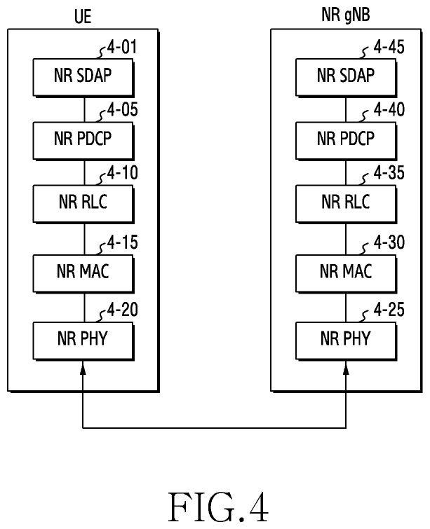

FIG. 4 is a diagram illustrating a wireless protocol structure of a next generation mobile communication system according to an embodiment of the disclosure.

Referring to FIG. 4, a wireless protocol of a next generation mobile communication system includes an NR service data adaptation protocol (SDAP) 4-01 or 4-45, an NR PDCP 4-05 or 4-40, an NR RLC 4-10 or 4-35, an NR MAC 4-15 or 4-30, and an NR PHY 4-20 or 4-25 in each of a terminal and an NR base station.

Main functions of the NR SDAP 4-01 or 4-45 may include some of the following functions. The NR SDAP may perform various functions without being limited to the following example.
Transfer of user data (transfer of user plane data).
Mapping between a QoS flow and a data bearer for uplink and downlink (mapping between a QoS flow and a DRB for both downlink (DL) and uplink (UL)).
Marking a QoS flow ID in uplink and downlink (marking QoS flow ID in both DL and UL packets).
Mapping a reflective QoS flow to a data bearer with respect to uplink SDAP PDUs (reflective QoS flow to DRB mapping for the UL SDAP PDUs).

In relation to the SDAP layer device, whether to use a function of the SDAP layer device or whether to use a header of the SDAP layer device may be configured for the terminal for each PDCP layer device, each bearer, or each logical channel, through a radio resource control (RRC) message received from the base station. When a SDAP header is configured, terminal may be indicated to update or reconfigure mapping information relating to a QoS flow and a data bearer for uplink and downlink, by using a non-access stratum (NAS) quality of service (QoS) reflective configuration 1-bit indicator (NAS reflective QoS) and an access stratum (AS) quality of service (QoS) reflective configuration 1-bit indicator (AS reflective QoS) of the SDAP header. The SDAP header may include QoS flow ID information indicating a QoS. The QoS information may be used as data processing priority, scheduling information, etc. for smoothly supporting services.

Main functions of the NR PDCP 4-05 or 4-40 may include some of the following functions. The NR PDCP may perform various functions without being limited to the following example.
Header compression and decompression (ROHC only).
Transfer of user data.
In-sequence delivery (In-sequence delivery of upper layer PDUs).
Out-of-sequence delivery (Out-of-sequence delivery of upper layer PDUs).
Reordering (PDCP PDU reordering for reception).
Duplicate detection (Duplicate detection of lower layer SDUs).
Retransmission (Retransmission of PDCP SDUs).
Ciphering and deciphering.
Timer-based SDU discard (Timer-based SDU discard in uplink).

The reordering of the NR PDCP device may mean reordering of PDCP PDUs received from a lower layer, according to the order of the PDCP sequence numbers (SNs). The reordering of the NR PDCP device may include a function of transferring data to a higher layer according to a rearranged order, a function of directly transferring data without considering order, a function of rearranging order to record lost PDCP PDUs, a function of reporting the state of lost PDCP PDUs to a transmission side, and a function of requesting retransmission of lost PDCP PDUs.

Main functions of the NR RLC 4-10 or 4-35 may include some of the following functions. The NR RLC may perform various functions without being limited to the following example.
Data transfer (Transfer of upper layer PDUs).
In-sequence delivery (In-sequence delivery of upper layer PDUs).
Out-of-sequence delivery (Out-of-sequence delivery of upper layer PDUs).
ARQ (Error correction through ARQ).
Concatenation, segmentation and reassembly (Concatenation, segmentation and reassembly of RLC SDUs).
Re-segmentation (Re-segmentation of RLC data PDUs).
Reordering (Reordering of RLC data PDUs).
Duplicate detection.
Error detection (Protocol error detection).
RLC SDU discard.
RLC re-establishment.

The in-sequence delivery function of the NR RLC device may mean a function of transferring RLC SDUs received from a lower to a higher layer according to order. The in-sequence delivery of the NR RLC device may include a function of, if a single RLC SDU is divided into several RLC SDUs and then the RLC SDUs are received, reassembling the several RLC SDUs and transmitting the reassembled RLC SDUs.

The in-sequence delivery of the NR RLC device may include a function of rearranging received RLC PDUs with reference to a RLC sequence number (SN) or a PDCP sequence number (SN), a function of rearranging order to record lost RLC PDUs, a function of reporting the state of lost RLC PDUs to a transmission side, and a function of requesting retransmission of lost RLC PDUs.

The in-sequence delivery of the NR RLC device may include a function of, if there is a lost RLC SDU, transferring only RLC SDUs before the lost RLC SDU to a higher layer according to order.

The in-sequence delivery of the NR RLC device may include a function of, although there is a lost RLC SDU, if a predetermined timer expires, transferring all the RLC SDUs received before the timer has started, to a higher layer according to order.

The in-sequence delivery of the NR RLC device may include a function of, although there is a lost RLC SDU, if a predetermined timer expires, transferring, all the RLC SDUs received until the current time point, to a higher layer according to order.

The NR RLC device may process RLC PDUs according to the order of receiving the RLC PDUs, regardless of the order of the sequence numbers (out-of-sequence delivery), and transfer the processed RLC PDUs to the NR PDCP device.

In a case of segment reception of the NR RLC device, the NR RLC device may receive segments that have been stored in a buffer or are to be received later, reconfigure the segments into a single intact RLC PDU, and transfer the RLC PDU to the NR PDCP device.

An NR RLC layer may not include a concatenation function, and the concatenation function may be performed in an NR MAC layer or replaced with a multiplexing function of an NR MAC layer.

The out-of-sequence delivery of the NR RLC device may mean a function of directly transferring RLC SDUs received from a lower layer, to a higher layer regardless of order. The out-of-sequence delivery of the NR RLC device may include a function of, if a single RLC SDU is divided into several RLC SDUs and then the RLC SDUs are received, reassembling the several RLC SDUs and transmitting the reassembled RLC SDUs. The out-of-sequence delivery of the NR RLC devices may include a function of storing RLC SNs or PDCP sequence numbers (SN)s of received RLC PDUs and sequencing the RLC PDUs to record lost RLC PDUs.

The NR MAC 4-15 or 4-30 may be connected to several NR RLC layer devices configured in a single terminal, and main functions of the NR MAC may include some of the following functions. The NR MAC may perform various functions without being limited to the following example.
Mapping (Mapping between logical channels and transport channels).
Multiplexing and demultiplexing (Multiplexing/demultiplexing of MAC SDUs).
Scheduling information reporting.
HARQ (Error correction through HARQ).
Priority handling between logical channels (Priority handling between logical channels of one UE).
Priority handling between UEs (Priority handling between UEs by means of dynamic scheduling).
MBMS service identification.
Transport format selection.
Padding.

The NR physical (PHY) layer 4-20 or 4-25 may perform channel coding and modulation of higher layer data to make the data into OFDM symbols and transmit the OFDM symbols through a wireless channel, or may perform demodulation and channel decoding of OFDM symbols received through a wireless channel, and then transfer the OFDM symbols to a higher layer. The NR physical layer may perform various functions without being limited to this example.

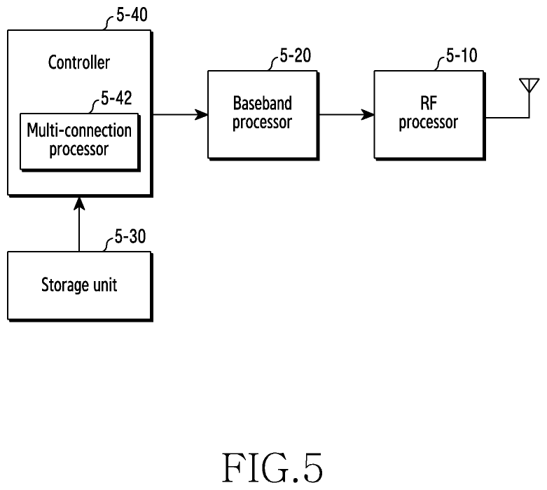

FIG. 5 is a block diagram illustrating an internal structure of a terminal according to an embodiment of the disclosure.

Referring to FIG. 5, the terminal may include a radio frequency (RF) processor 5-10, a baseband processor 5-20, a storage unit 5-30, and a controller 5-40.

The RF processor 5-10 performs a function, such as signal band change, amplification, etc., for transmitting or receiving a signal through a wireless channel. That is, the RF processor 5-10 may upconvert a baseband signal provided from the baseband processor 5-20, into an RF band signal, and then transmit the RF band signal through an antenna, and downconvert an RF band signal received through the antenna, into a baseband signal. For example, the RF processor 5-10 may include a transmission filter, a reception filter, an amplifier, a mixer, an oscillator, a digital-to-analog converter (DAC), an analog-to-digital converter (ADC), and the like. In FIG. 5, only one antenna is illustrated, but the terminal may include a plurality of antennas. In addition, the RF processor 5-10 may include a plurality of RF chains. Furthermore, the RF processor 5-10 may perform beamforming. For beamforming, the RF processor 5-10 may adjust the phase and size of each signal transmitted or received through a plurality of antennas or antenna elements. In addition, the RF processor 5-10 may perform multi-input multi-output (MIMO), and may receive several layers at the time of performing an MIMO operation.

The baseband processor 5-20 may perform a function of conversion between a baseband signal and a bitstream according to physical layer specifications of a system. For example, when data is transmitted, the baseband processor 5-20 may generate complex symbols by encoding and modulating a transmission bitstream. In addition, when data is received, the baseband processor 5-20 reconstructs a reception bit stream by demodulating and decoding a baseband signal provided from the RF processor 5-10. For example, in a case where an orthogonal frequency division multiplexing (OFDM) scheme is applied, when data is transmitted, the baseband processor 5-20 may generate complex symbols by encoding and modulating a transmission bitstream, map the complex symbols to subcarriers, and then configure OFDM symbols through inverse fast Fourier transform (IFFT) calculation and cyclic prefix (CP) insertion. In addition, when data is received, the baseband processor 5-20 may divide a baseband signal provided from the RF processor 5-10, by the units of OFDM symbols, reconstruct signals mapped to subcarriers, through fast Fourier transform (FFT), and then reconstruct a reception bit stream through demodulation and decoding.

The baseband processor 5-20 and the RF processor 5-10 transmit and receive a signal as described above. Accordingly, the baseband processor 5-20 and the RF processor 5-10 may be called a transmitter, a receiver, a transceiver, or a communication unit. Furthermore, at least one of the baseband processor 5-20 and the RF processor 5-10 may include a plurality of communication modules to support a plurality of different wireless access technologies. In addition, at least one of the baseband processor 5-20 and the RF processor 5-10 may include different communication modules to process signals in different frequency bands. For example, the different wireless access technologies may include wireless LAN (e.g., IEEE 802.11), cellular network (e.g., LTE), etc. Furthermore, the different frequency bands may include a super high frequency (SHF) (e.g., 2.NRHz, NRhz) band, a millimeter (mm) wave (e.g., 60 GHz) band, etc. The terminal may transmit and receive a signal with a base station by using the baseband processor 5-20 and the RF processor 5-10. The signal may include control information and data.

The storage unit 5-30 stores data such as a basic program, an application program, and configuration information for an operation of the terminal. Particularly, the storage unit 5-30 may store information related to a second access node that performs wireless communication by using a second wireless access technology. The storage unit 5-30 provides stored data in response to a request of the controller 5-40.

The controller 5-40 controls overall operations of the terminal. For example, the controller 5-40 transmits or receives a signal via the baseband processor 5-20 and the RF processor 5-10. In addition, the controller 5-40 records and reads data in and from the storage unit 5-40. To this end, the controller 5-40 may include at least one processor. For example, the controller 5-40 may include a multi-connection processor 5-42. Alternatively or additionally, the controller 5-40 may include a communication processor (CP) performing control for communication, and an application processor (AP) controlling a higher layer, such as an application program.

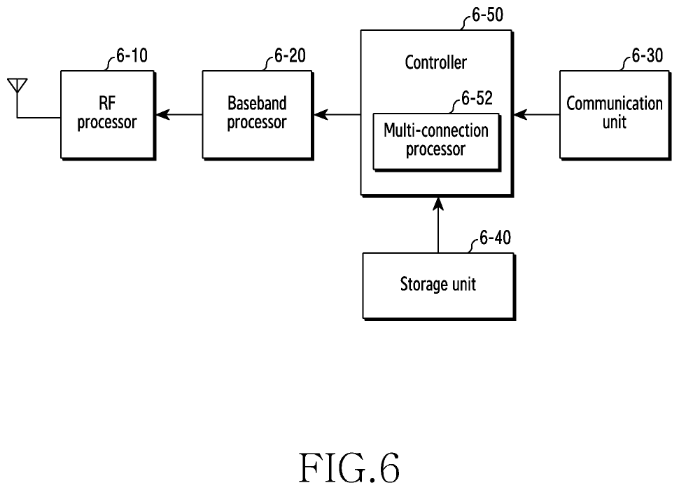

FIG. 6 is a block diagram illustrating a configuration of an NR base station according to an embodiment of the disclosure.

Referring to FIG. 6, the base station may include an RF processor 6-10, a baseband processor 6-20, a communication unit 6-30, a storage unit 6-40, and a controller 6-50.

The RF processor 6-10 performs a function, such as signal band change, amplification, etc., for transmitting or receiving a signal through a wireless channel. That is, the RF processor 6-10 may upconvert a baseband signal provided from the baseband processor 6-20, into an RF band signal, and then transmit the RF band signal through an antenna, and downconvert an RF band signal received through the antenna, into a baseband signal. For example, the RF processor 6-10 may include a transmission filter, a reception filter, an amplifier, a mixer, an oscillator, a DAC, an ADC, and the like. In FIG. 6, only one antenna is illustrated, but the base station may include a plurality of antennas. In addition, the RF processor 6-10 may include a plurality of RF chains. Furthermore, the RF processor 6-10 may perform beamforming. For beamforming, the RF processor 6-10 may adjust the phase and size of each signal transmitted or received through a plurality of antennas or antenna elements. The RF processor may perform a downlink MIMO operation by transmitting at least one layer.

The baseband processor 6-20 performs a function of conversion between a baseband signal and a bit stream according to a physical layer specification of a wireless access technology. For example, when data is transmitted, the baseband processor 6-20 may generate complex symbols by encoding and modulating a transmission bitstream. In addition, when data is received, the baseband processor 6-20 reconstructs a reception bit stream by demodulating and decoding a baseband signal provided from the RF processor 6-10. For example, in a case where an OFDM scheme is applied, when data is transmitted, the baseband processor 6-20 may generate complex symbols by encoding and modulating a transmission bitstream, map the complex symbols to subcarriers, and then configure OFDM symbols through IFFT calculation and CP insertion. In addition, when data is received, the baseband processor 6-20 may divide a baseband signal provided from the RF processor 6-10, by the units of OFDM symbols, reconstruct signals mapped to subcarriers, through FFT, and then reconstruct a reception bit stream through demodulation and decoding. The baseband processor 6-20 and the RF processor 6-10 may transmit and receive a signal as described above. Accordingly, the baseband processor 6-20 and the RF processor 6-10 may be called a transmitter, a receiver, a transceiver, a communication unit, or a wireless communication unit. The base station may transmit and receive a signal with a terminal by using the baseband processor 6-20 and the RF processor 6-10. The signal may include control information and data.

The backhaul communication unit 6-30 provides an interface for performing communication with other nodes within a network. That is, the backhaul communication unit 6-30 converts, into a physical signal, a bitstream transmitted from a main base station to another node, for example, an auxiliary base station, a core network, etc., and converts a physical signal received from the other node, into a bitstream.

The storage unit 6-40 stores data such as a basic program, an application program, and configuration information for an operation of the main base station. Particularly, the storage unit 6-40 may store information on a bearer assigned to a connected terminal, a measurement result reported from a connected terminal, etc. In addition, the storage unit 6-40 may store information serving as a determination criterion of whether to provide or stop providing multi-connection to a terminal. The storage unit 6-40 provides stored data in response to a request of the controller 6-50.

The controller 6-50 controls overall operations of the main base station. For example, the controller 6-50 transmits or receives a signal via the baseband processor 6-20 and the RF processor 6-10, or via the backhaul communication unit 6-30. In addition, the controller 6-50 records and reads data in and from the storage unit 6-40. To this end, the controller 6-50 may include at least one processor. For example, the controller 6-50 may include a multi-connection processor 6-52.

In a recent mobile communication system, a mobile IAB node has been introduced into the standard. Accordingly, a localization service are also considered important as well as conventional voice and/or data communication for terminals receiving communication services in a cell operated by a mobile IAB node. Almost conventional localization schemes provides a localization service, based on the real locations of transmission reception points (TRPs) operated by a fixed serving base station and/or a neighboring base station. More specifically, a terminal has measured the location of a target terminal by a method of receiving a downlink (DL) signal from TRPs and transferring a result thereof to a location management function (LMF), or transmitting an uplink (UL) sounding reference signal (SRS) and receiving, by the TRP, the UL SRS and transferring measured information to the LMF via a gNB.

Due to the mobility of a mobile IAB node, a cell operated by the corresponding node is also moved. Therefore, a localization service for a terminal receiving a service from a mobile IAB node is possible only if the accuracy of the location of a moving cell is secured.

The following description provides a method for improving a conventional TRP information request/response message for location information of a moving cell.

According to an embodiment, when an LMF transfers a TRP information request message to a gNB, the LMF may indicate a requested TRP ID or a requested type of TRP information to request a response.
In an embodiment, a TRP information request message may indicate a TRP ID and a type of TRP information to be identified. The LMF may request at least one type of TRP information among the following types of information from the gNB through the TRP information request message.
The types of TRP information may include a physical cell ID (PCI) of a cell in which the TRP is operating, a cell global identity (CGI) of the cell, a frequency information absolute radio frequency channel number (ARFCN) of the cell, configuration information on a positioning reference signal (PRS) transmitted from the TRP, information of a synchronization signal block (SSB) transmitted from the TRP (an SSB transmission frequency, a transmitted SSB index, a transmission period, a transmission start window duration, window start time information, etc.), a spatial direction, geographical coordinates of the TRP or an antenna part of the TRP, a TRP type (Tx only, Rx only, or both possible), information about an on-demand PRS (on-demand-available PRS configuration information), and TRP Tx timing error group (TEG) association (timing error information between each antenna part and a baseband node at the time of transmission of a DL PRS from the TRP).
Additionally, the LMF may include an indicator requesting a cell status/cell mobility state/cell mobility status in the TRP info type. The indicator may be included for each TRP. Alternatively, the indicator may be included in a field having a level greater than that of a TRP. When the indicator is received, the gNB having received same may perform the following operations.
The gNB may include, in a TRP info response message, a 1-bit indication indicating that the TRP is a moving cell, which may be included for each TRP ID, and transmit the message.
The gNB may include and transmit an information element (IE) indicating that the TRP is a moving cell, and subsequent type information corresponding to at least one of the following pieces of information.
The type information may include an indicator indicating a ground moving cell or an aerial cell.
Additionally/alternatively, size information, a Tx power class, or transport type information (bus, train, or UAM) of the moving cell may be indicated.
Additionally/alternatively, a moving speed of the moving cell may also be included.
If the TRP is a moving cell, the gNB may add and transmit time information on a time at which TRP information is measured.
The above pieces of information may be reported even though a TRP information request message does not include a moving cell status request indicator.
In an embodiment, the gNB having received a TRP information request message may accommodate information required for the indicated TRP in a TRP information response message and transfer same to the LMF.

According to an embodiment of the disclosure, for reporting of a response message for the TRP information request message, the LMF may include an indicator indicating a periodic report or an event-driven report in the TRP information request message and transfer same.
In an embodiment, a TRP information request message may also include period information used for reporting together with a periodic report indicator.
In an embodiment, when a TRP information request message including a periodic report indicator and period information is received, the gNB may transmit, to the LMF and every given period, corresponding TRP information for a TRP ID and a required TRP information type included in the TRP information request message.
In this case, a message transferring the TRP information may be a TRP information response, or if the message is a separate periodic response, the message may be a new message called a TRP information update.
   if the TRP information response is not a periodic report, a TRP information response message may be used, and if the response is a periodic report, a TRP information update message may be used.
If the required information is location information or geographical coordinate information of a TRP (or an antenna part of the TRP), when the information is transmitted to the LMF, the gNB may include and transmit time stamp information on a time point at which the location information of the TRP is obtained, or on a latest time at which the gNB determines that the location information of the TRP is valid.
In a case where a periodic report is indicated, if information to be transmitted at a current period is not changed from TRP information transmitted at a previous period, the gNB may not include the corresponding information, and include an indicator indicating that there is no change, in a response message (TRP information response or TRP information update), and transmit same. As another embodiment, if there is no changed information at a current period compared to a previous period, the gNB may not transmit a response message.
In an embodiment, the LMF may contain an indicator indicating an event-driven report, in a TRP information request message and transmit same to the gNB.
The LMF may include, in the TRP information request message, a particular threshold value for a distance or an angle on geographical coordinates.
When, after a time point of reception of the TRP information request message including the threshold value, there occurs a location change equal to or greater than the threshold value from a TRP location at the time point, or when there occurs a location change equal to or greater than the threshold value compared to TRP (or the antenna part of the TRP) location information on a TRP information response/update message previously transferred from the gNB to the LMF, the gNB having received the message may include the location value in a new TRP information response (or update) message and transfer same to the LMF.
The threshold value and a particular TRP location value may be included in the TRP information request message. In this case, if the TRP location is changed by the threshold value or greater with respect to the given location value, the gNB may include the location value in a response message (or update message) and transfer same to the LMF.
The types of the threshold value may include the following pieces of information.
Threshold information includes:
With respect to each value of latitude and longitude:
   One angle threshold value (if there occurs an angle change equal to or greater than a threshold value for each latitude/longitude, this change is considered as a location change);
   Two angle threshold values (if there occurs an angle change equal to or greater than a threshold value corresponding to latitude east/west, and if there occurs an angle change equal to or greater than a threshold value corresponding to longitude north/south, this change is considered as a location change);
   One absolute distance threshold value (a threshold value in a current latitude-based east/west distance direction, that is, an east/west distance direction along the same longitude line);
   One absolute distance threshold value (a threshold value in a current longitude-based north/south distance direction, that is, a north/south distance direction along the same latitude line); or
   Two absolute distance threshold values:
      In a case of latitude, a separate distance threshold value corresponding to east/west is configured; and/or
      In a case of longitude, a separate distance threshold value corresponding to north/south is configured.
With respect to an altitude value:
   One absolute altitude threshold value (if there occurs an altitude change having the same value upward/downward from the altitude of a current or given location, this change is considered as a location change); or
   Two absolute altitude threshold values (a separate threshold value for up/down is configured).
An uncertainty threshold value is configured through uncertainty semi major:
   If uncertainty exceeding a threshold value occurs, this is considered as a location change.
A condition of latitude, a condition of longitude, a condition of altitude, and a condition of uncertainty may be components configuring one large condition. In this case, particular elements may be grouped by logical AND to configure a condition, and some elements may be configured by a condition of logical OR. For example, in a case of (latitude condition) AND (longitude condition) OR (altitude condition), a condition of TRP information update transmission may be that the latitude condition and the longitude condition are simultaneously satisfied or the altitude condition is satisfied.
When a change involving a cell or TRP of the gNB being added or removed occurs in the TRP information request message, the gNB may report the change to the LMF by using a TRP information update/response message.
When a new cell or TRP is added to the gNB, the gNB may report the corresponding added TRP ID and pieces of TRP information.
The transferred information is as follows.
   Mandatory: TRP ID, and PCI and/or NR ARFCN and/or NCGI;
   Moving cell status: An indicator indicating whether the TRP is a moving cell; and/or
   TRP location IE (legacy reference).
When a cell or TRP previously reported to the gNB has disappeared/been removed, the gNB may report the corresponding removed TRP ID and the removal of the TRP.
The above operation may also be performed without an indication by the LMF, or
The addition of the TRP and the information thereof or the removal of the TRP may be reported when the gNB receives a TRP information request including an autonomous TRP update indicator from the LMF.
In an embodiment, if a TRP information request message does not include a periodic report indicator or includes an on-demand indicator, this may indicate a one-time TRP information response.

In an embodiment, a signal system between the LMF and the gNB uses an NR positioning protocol A (NRPPa) interface. Accordingly, TRP information request/response/update messages may all be messages on an NRPPa protocol. In addition, an NRPPa message and address information between a particular gNB and an LMF may be obtained in association with an access and mobility management function (AMF).

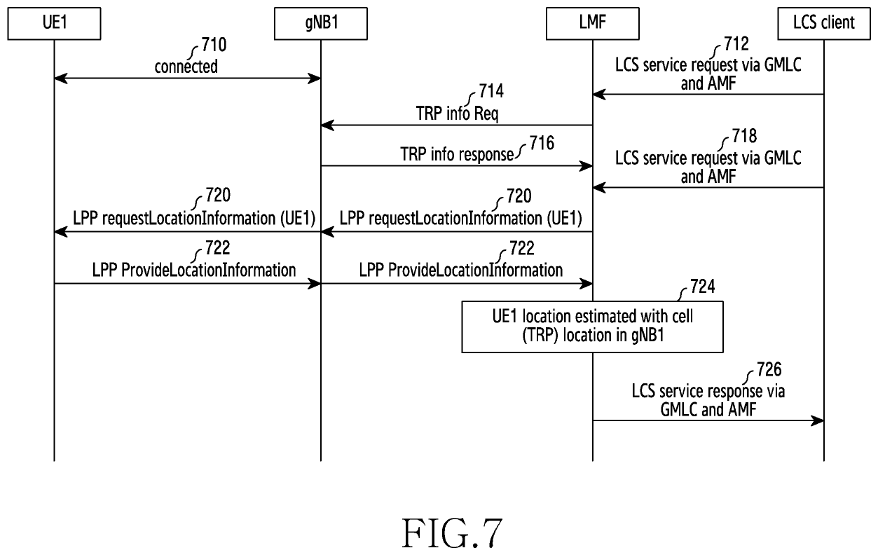

FIG. 7 is a diagram illustrating an operation of transmitting a TRP information request/response message in a process of obtaining location information of a terminal according to an embodiment of the disclosure.

An entity that requests an LCS service may be an LCS client of an external network, an AMF, or a particular terminal, but FIG. 7 illustrates an LCS client of an external network. When terminal 1 (UE 1) and gNB 1 are in a connected state (or an inactive/idle state is also possible) 710, it is assumed that a serving relation between a serving gNB, that is, gNB 1 and terminal 1 has been known via an AMF. Accordingly, an LMF may also recognize a serving gNB of a particular target terminal. The LMF may receive an LCS service request message 712 or 718 from the LCS client to receive a request for a location service for a particular target terminal (here, terminal 1). The LCS service request message may reach the LMF via a GMLC and the AMF.

The LMF may identify a target terminal and a requirement of a requested localization service through the LCS service request message. Thereafter, the LMF may transmit a TRP information request message 714 to the serving gNB (gNB 1) of the target terminal to request pieces of information on a particular or all TRPs of gNB 1. gNB 1 may receive the TRP information request message and then respond for the requested information of the requested TRP to the LMF by using a TRP information response message 716.

The LCS service request message may be received before 712 or after 718 the TRP information request/response message is exchanged between the LMF and gNB 1. If the LCS service request message is received before 712 the TRP information request/response message 714 and 716 is exchanged between the LMF and gNB 1, a TRP information request message 714 may be transmitted to serving gNB 1 of the target terminal, and gNB 1, which is a serving gNB, may transmit a TRP information response message 716. If the LCS service request message is received after 718 the TRP information request/response message is exchanged, the LMF may perform an LPP message procedure with the target terminal without exchanging an additional TRP information request/response message. Location measurement and reporting may be requested to the terminal (UE 1) through an LTE positioning protocol (LPP) RequestLocationInformation message 720. The terminal (UE1) having received the LPP RequestLocationInformation message 720 via the serving gNB (gNB 1) may measure a relevant reference signal and transmit a result thereof to the LMF through an LPP ProvideLocationInformation message 722. The LMF is aware of TRP location information by previously obtaining TRP information, and thus may estimate the location of terminal 1 (UE 1) 724, based on the location of a TRP among serving cells of the serving gNB (gNB 1) of the terminal (UE 1). The LMF may transmit location information 726 described above to the LCS client having requested the LCS service.

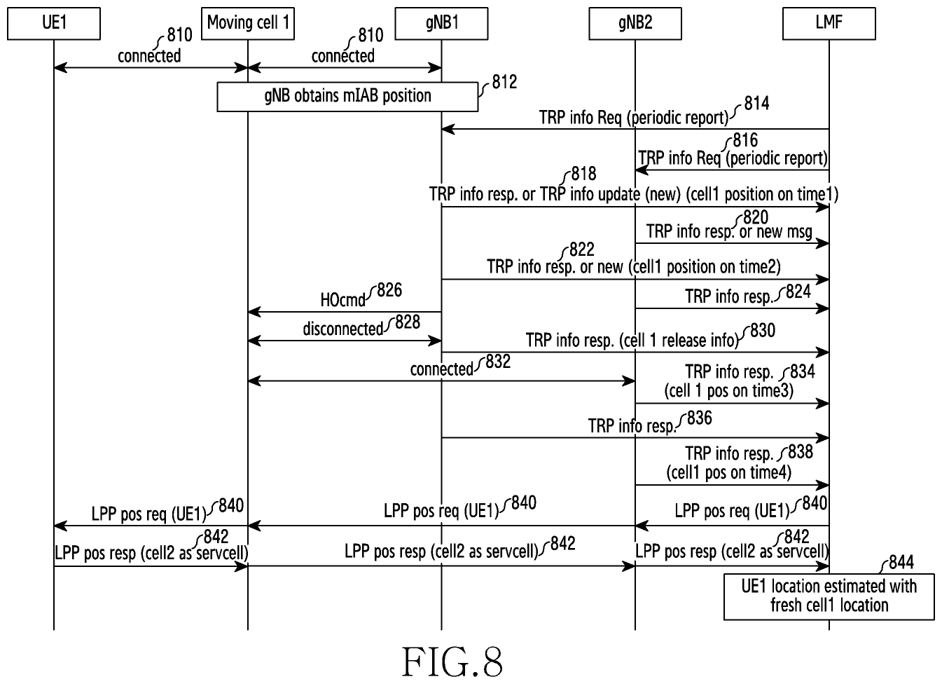

FIG. 8 is a diagram illustrating an operation of periodically transmitting one TRP information response message according to an embodiment of the disclosure.

Referring to FIG. 8, a process of transmitting an LCS service request message is omitted, and as described with reference to FIG. 7, an LCS client of an external network, an AMF, or a particular target terminal may transmit an LCS service request message for a particular terminal to an LMF. FIG. 8 illustrates subsequent operations.

Referring to FIG. 8, moving cell 1 which is served by gNB 1 is serving UE 1. The terminal (UE 1) is in a connected state 810, and gNB 1 may obtain the location of moving cell 1 812 in various methods. These methods may include an LPP/NRPPa positioning method or an update by an OAM server. In addition, moving cell 1 may be implemented by a mobile IAB node. Accordingly, gNB 1 is already aware of a mobile IAB node (mIAB node) that is a combination of a mobile terminal (MT) and a distributed unit (DU) of moving cell 1. An AMF has received, from gNB 1, and stored a cell of gNB 1 and the mIAB node at a time point at which the mIAB node accesses gNB 1 and the ID of a terminal being served in the cell.

Based on the information of the AMF, the LMF may request TRP information of gNB 1 814 and/or information of gNB 2 816. In this case, a TRP information request message may include an indicator indicating to periodically report TRP information to the LMF. Period information may be transferred together. Based on the indicator, gNB 1 and/or gNB 2 may, based on the period information transferred together with the indicator, accommodate, in a response message or update message 818 and 820, and transfer, to the LMF, TRP information requested for a determined or all TRPs of each gNB every period. The transferred information may include the above pieces of information.

Referring to FIG. 8, it is assumed that moving cell 1 is actually moving, and thus gNB 1 and/or gNB 2 may update TRP location information in the moving cell that is moving 822 and 824. Accordingly, location information of a TRP in the moving cell may be transferred to the LMF every particular period.

While moving, moving cell 1 may be handed over to a central unit (CU) of another gNB. This handover process may be performed through a process of handover of the MT of the mIAB node. gNB 1 may request gNB 2 to move the MT of the mIAB node, and when gNB2 accepts the request, gNB 2 may accommodate configuration information to be used, in a HO layer and transfer same to the MT of the mIAB node via the gNB 1 (HO cmd) 826. The MT having received the information may perform handover and transfer an RRCReconfigurationComplete message to gNB 2, thereby completing the handover.

Thereafter, operation of moving cell 1 may be resumed through additional signaling between the DU of mIAB and the CU of gNB 2. In this process, a TRP information response message may also transfer information related to addition/removal of a cell (and/or a TRP associated with the cell) that is being operated by gNB 1 and/or gNB 2. Accordingly, when moving cell 1 of gNB 1 has disappeared due to handover 828, gNB 1 may include, in a response message, and transfer, to the LMF, the corresponding cell, the TRP ID of the cell, and an indicator indicating that the cell has been removed 830, at a next TRP information transfer period after recognizing the disappearance. Similarly, the gNB 2 CU having received a cell operated by the DU of the mIAB node and TRP information after HO completion 832 may transfer, to the LMF, a cell added by the mIAB node at a period after a time point of recognition of the information is recognized 834, and TRP information associated with the cell by using a TRP information response/update message.

In a state where the LMF is able to periodically update location information of the moving cell 836 and 838, if an LCS request message of terminal 1 (UE 1) is received, the LMF may use an LPP requestLocationInformation message 840 to request terminal 1 (UE 1) to measure a relevant reference signal and report a measurement result. Terminal 1 (UE 1) may perform measurement and report a result thereof to the LMF through LPP ProvideLocationInformation 842. After receiving the information, the LMF may estimate the location of UE 1 844, based on the TRP location of the moving cell by which UE 1 is currently being served. The LMF may report the information to an entity having transferred the LCS service request message.

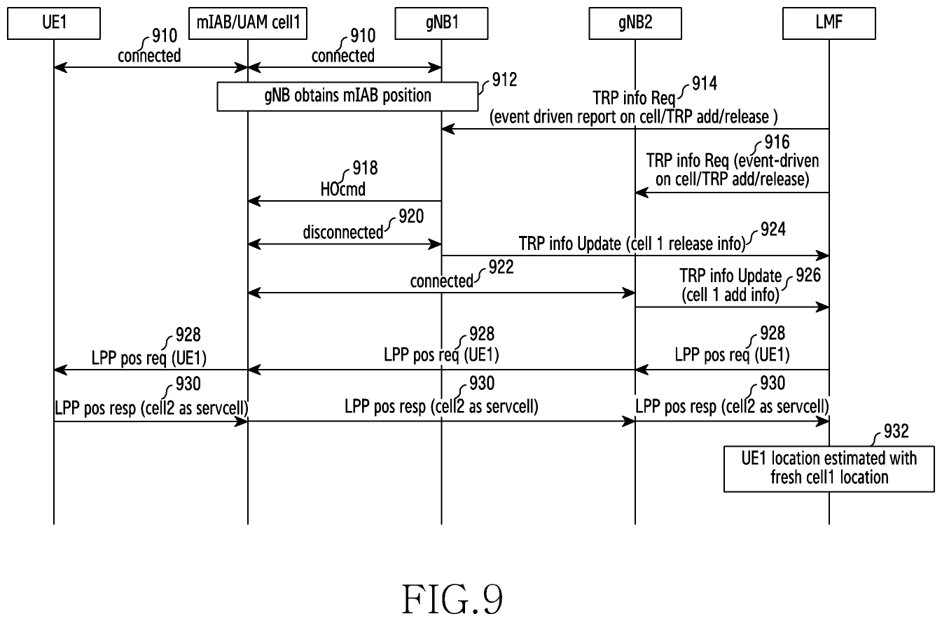

FIG. 9 is a diagram illustrating an operation of requesting an event-driven TRP information response/update according to an embodiment of the disclosure.

Similarly in FIG. 8, a process of transmitting an LCS service request message is omitted in FIG. 9, and as described with reference to FIG. 7, an LCS client of an external network, an AMF, or a particular target terminal may transmit an LCS service request message for a particular terminal to an LMF. FIG. 9 illustrates subsequent operations.

Referring to FIG. 9, moving cell 1 which is served by gNB 1 is serving UE 1. The terminal (UE 1) is in a connected state 910, and gNB 1 may obtain the location of moving cell 1 912 in various methods. These methods may include an LPP/NRPPa positioning method or an update by an OAM server. In addition, moving cell 1 may be implemented by a mobile IAB node. Accordingly, gNB 1 is already aware of a mobile IAB node that is a combination of a MT and a DU of moving cell 1. An AMF has received, from gNB 1, and stored a cell of gNB 1 and the mIAB node at a time point at which the mIAB node accesses gNB 1 and the ID of a terminal being served in the cell.

Based on the information of the AMF, the LMF may request TRP information of gNB 1 and/or gNB 2 914 and 916. In this case, a TRP information request message may include a TRP information specifying condition. In addition, the message may include an indicator indicating a gNB to report a response to the LMF when the condition is satisfied.

The condition may include the above conditions.

gNB 1 and gNB 2 having received the configuration may transfer new location information of a corresponding TRP to the LMF when the location of the moving cell has moved by a configured range or more. And/or, when a cell addition/removal event occurs in a gNB level, gNB 1 and gNB 2 may transfer new TRP information for the event. Referring to FIG. 9, when moving cell 1 moves from gNB 1 to gNB 2 and gNB 1 recognizes the movement 918, 920, and 922, gNB 1 may report, to the LMF, information indicating that the moving cell and an associated TRP have been removed (released) 924. In addition, gNB 2 may transfer, to the LMF, information indicating that the moving cell and an associated TRP have been added 926, together with detailed information of the TRP.

In a state where the LMF is able to periodically update location information of the moving cell, if an LCS request message of terminal 1 (UE 1) is received, the LMF may use an LPP requestLocationInformation message 928 to request terminal 1 (UE 1) to measure a relevant reference signal and report a measurement result. Terminal 1 (UE 1) may perform measurement and report a result thereof to the LMF through LPP ProvideLocationInformation 930. After receiving the information, the LMF may estimate the location of UE 1 932, based on the TRP location of the moving cell by which UE 1 is currently being served. The LMF may report the information to an entity having transferred the LCS service request message.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included in the electronic device.

In addition, the programs may be stored in an attachable storage device which may access the electronic device through communication networks such as the Internet, Intranet, Local Area Network (LAN), Wide LAN (WLAN), and Storage Area Network (SAN) or a combination thereof. Such a storage device may access the electronic device via an external port. Further, a separate storage device on the communication network may access a portable electronic device.

In the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Furthermore, in methods of the disclosure, some or all of the contents of each embodiment may be implemented in combination without departing from the essential spirit and scope of the disclosure.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a base station in a wireless communication system, the method comprising:
receiving, from a location management function (LMF) entity, a transmission reception point (TRP) information request message including at least one TRP identification (ID); and
transmitting, to the LMF entity, a TRP information response message including first indication information indicating that a TRP corresponding to the at least one TRP ID is a moving cell.

2. The method of claim 1,
wherein the TRP information request message further includes at least one type of TRP information, and
wherein the at least one type of TRP information includes a speed of the moving cell and time information of measurement for the TRP information.

3. The method of claim 1,
wherein the TRP information request message further includes second indication information indicating a periodic report with period information, and
wherein the TRP information response message is transmitted periodically based on the period information.

4. The method of claim 1,
wherein the TRP information request message further includes second indication information indicating an event driven report with threshold information, and
wherein the TRP information response message is transmitted based on the threshold information.

5. The method of claim 1, further comprising:
in case that a cell is added or removed, transmitting, to the LMF entity, the TRP information response message including information associated with the cell.

6. A method performed by a location management function (LMF) entity in a wireless communication system, the method comprising:
transmitting, to a base station, a transmission reception point (TRP) information request message including a TRP identification (ID); and
receiving, from the base station, a TRP information response message including indication information indicating that a TRP corresponding to the TRP ID is a moving cell.

7. The method of claim 6,
wherein the TRP information request message further includes at least one type of TRP information, and
wherein the at least one type of TRP information includes a speed of the moving cell and time information of measurement for the TRP information.

8. The method of claim 6,
wherein the TRP information request message further includes second indication information indicating a periodic report with period information, and
wherein the TRP information response message is received periodically based on the period information.

9. The method of claim 6,
wherein the TRP information request message further includes second indication information indicating an event driven report with threshold information, and
wherein the TRP information response message is received based on the threshold information.

10. The method of claim 6, further comprising:
in case that a cell is added or removed to the base station, receiving, from the base station, the TRP information response message including information associated with the cell.

11. A base station in a wireless communication system, the base station comprising:
a transceiver; and
a controller coupled to the transceiver, and configured to:
receive, from a location management function (LMF) entity, a transmission reception point (TRP) information request message including at least one TRP identification (ID), and
transmit, to the LMF entity, a TRP information response message including first indication information indicating that a TRP corresponding to the at least one TRP ID is a moving cell.

12. The base station of claim 11,
wherein the TRP information request message further includes at least one type of TRP information, and
wherein the at least one type of TRP information includes a speed of the moving cell and time information of measurement for the TRP information.

13. The base station of claim 11,
wherein the TRP information request message further includes second indication information indicating a periodic report with period information, and
wherein the TRP information response message is transmitted periodically based on the period information.

14. The base station of claim 11,
wherein the TRP information request message further includes second indication information indicating an event driven report with threshold information, and
wherein the TRP information response message is transmitted based on the threshold information.

15. The base station of claim 11, wherein the controller is further configured to:
in case that a cell is added or removed, transmit, to the LMF entity, the TRP information response message including information associated with the cell.

16. A location management function (LMF) entity in a wireless communication system, the LMF entity comprising:
a transceiver; and
a controller coupled to the transceiver, and configured to:
transmit, to a base station, a transmission reception point (TRP) information request message including a TRP identification (ID), and
receive, from the base station, a TRP information response message including indication information indicating that a TRP corresponding to the TRP ID is a moving cell.

17. The LMF entity of claim 16,
wherein the TRP information request message further includes at least one type of TRP information, and
wherein the at least one type of TRP information includes a speed of the moving cell and time information of measurement for the TRP information.

18. The LMF entity of claim 16,
wherein the TRP information request message further includes second indication information indicating a periodic report with period information, and
wherein the TRP information response message is received periodically based on the period information.

19. The LMF entity of claim 16,
wherein the TRP information request message further includes second indication information indicating an event driven report with threshold information, and
wherein the TRP information response message is received based on the threshold information.

20. The LMF entity of claim 16, wherein the controller is further configured to:
in case that a cell is added or removed to the base station, receiving, from the base station, the TRP information response message including information associated with the cell.
